(19) United States
(12) Patent Application Publication
(10) Pub. No.: US 2009/0065527 A1
(43) Pub. Date: Mar. 12, 2009

(54) Device and method for the release of material for processing

(76) Inventor: Manuel Buck, Gebenstorf (CH)

Correspondence Address: BINGHAM MCCUTCHEN LLP, 2020 K Street, N.W., Intellectual Property Department, WASHINGTON, DC, 20006, US

(21) Appl. No.: 11/984,963

(22) Filed: Nov. 26, 2007

Related U.S. Application Data
(63) Continuation of application No. 11/629,480, now abandoned.

(30) Foreign Application Priority Data
Jun. 14, 2004 (EP) 04102700.4

(51) Int. Cl. B05C 17/005; B65D 35/28; B65D 35/56; G01F 11/00

(52) U.S. Cl. 222/95; 222/105; 222/1; 222/386

(57) ABSTRACT

The device (10) for the release of material (202) for processing, comprises an actuator device (800), by means of which a guide rod (1), mounted for axial displacement, provided on the front thereof with a threaded pin (12) for connection to a piston (5), may be introduced into a cylinder (9; 309), such that the piston (5) acts on the material (202) for processing in the cylinder (9; 309) and forces the same from the cylinder (9; 309). According to the invention, the piston (5) comprises two opposing faces (5A, 5B), the first face (5A) of which acts on the material (202) for processing, housed in a bag (200), introduced into the cylinder (9) and the second face (5B) of which acts on material (202) for processing housed in the cylinder (309) in a cartridge (300) introduced into the device (10). The device (10) thus permits, after corresponding assembly of the piston (5), the processing of a bag introduced into the cylinder (9), or a cartridge (300) which may be inserted in the device (10).

### TECHNICAL DOMAIN

The present invention is based on a device for the delivery of materials to be used, more particularly viscous or pasty materials such as sealants and agglutinants in accordance with the preamble of the first claim.

The present invention relates furthermore to a method for delivering said materials to be used in accordance with the independent method claims.

### THE STATE OF THE ART

Devices of this type, which are known by the names of injection pistol, Caulk Gun or Sealant Gun, and which have been disclosed, for example, in JP 11036571, JP 2003213926, JP 7041021, serve in the measured delivery of a sealant. Devices of this type are typically fitted with either a manual, an electric or a pneumatic actuation apparatus. Electrically-powered devices are manufactured, for example, by the MILWAUKEE ELECTRIC TOOL CORPORATION, e.g. production series 6560-2x.

The device disclosed in JP 11036571 permits the delivery of sealant from a sausage-shaped bag that can be inserted into a cylinder of the device, which cylinder, being a component of the device, can be recharged with bags an unlimited number of times.

The device disclosed in JP 2003213926 permits the delivery of sealant contained in a single-use cartridge that can be inserted into a suitable holding element of said device and, following use, be removed therefrom.

JP 7041021 discloses that even multiple-use cartridges can be employed, whereby such cartridges can be recharged and re-used following insertion of a sausage-shaped bag.

The use of bags containing sealant instead of single-use cartridges has the advantage that such bags on the one hand are easier to insert and, on the other hand, following use, generate little waste. However, use of bags requires employment of a suitably-adapted apparatus.

The device disclosed in JP 11036571, which can be charged with bags, features a cylinder which, serving to accommodate one bag, is non-permanently connected at one end by means of a first assembly ring to a conical covering piece and at the other end by means of a second assembly ring to an actuation apparatus inside which a guide rod is borne so as to be able to slide. Aided by the manually-powered actuation apparatus, the guide rod, which is fitted at its forward end with a piston, can be introduced into the cylinder, wherein the piston is brought to bear upon the inserted bag in such a way that sealant is caused to flow out of the bag, which is snipped open at its forward end, and through the conical covering piece. In JP11036571, the design of the piston through which the threaded end piece of the guide rod is axially introduced prevents the bag casing from catching between piston and cylinder and ripping open, whereby on the one hand the piston acts to block and on the other hand sealant is permitted to flow out into the cylinder inside the piston region. In addition, the piston is manufactured from a single elastic piece at whose periphery an annulus presses wedge-like against the inner wall of the cylinder so as to cause the bag casing, which folds as it empties, to be forced inwardly. The solution to the same problem is also disclosed in JP 7041021.

Application of the devices disclosed in JP 11036571 and JP 7041021 has revealed that, once the bag has been emptied, a not-insignificant quantity of sealant always remains therein.

It was also discovered that, after a bag had been emptied, the piston could, if the cylinder were disengaged from the second assembly ring, become detached from the guide rod, which would then have to be grasped by hand and reassembled, which would permit unwanted contact with the sealant. In the device described in JP 11036571, in which the piston is held between two screw nuts, it was discovered that one of these nuts could work loose were the cylinder and the piston, which presses against the inner wall thereof, to be rotated relative to the guide rod.

Due to the various demands made on the device, which become evident when bags or cartridges are being worked, the prior art devices have not enabled optimal employment of bags and cartridges in the same device.

### DISCLOSURE OF THE PRESENT INVENTION

The objective of the present invention is, therefore, the creation of an improved device and method of the type first mentioned, serving the delivery of material to be used, especially viscous or pasty material, such as sealant or agglutinant.

It is particularly important that both device and method for the optimal working of bags and cartridges containing material to be processed be well matched. Such matching of device and method should permit the more effective emptying of a bag inserted into a cylinder to be worked, and the bag, once emptied, should be capable of removal without difficulty. A further objective of the proposed device is to ensure that operating interruptions will be avoided even following multiple reloadings with bags. Another objective of the proposed device and method is to obviate both any damage to the bags and cartridges being worked and thus also any unwanted leakage of sealant. In addition, it is proposed that the unwanted loosening of device parts, even following multiple bag reloads, be obviated by means of the novel apparatus and method. The proposed device should, additionally, be suitable for use with different types of actuation apparatus.

It is proposed that these objectives be satisfied by means of the distinguishing features of the first claim. Further advantageous embodiments of the present invention are disclosed in the subsidiary claims.

The device serving to dispense material to be processed features an actuation apparatus, by means of which a guide rod, provided at its forward end with a threaded bolt that permits said guide rod to attach to a piston, is borne so as to be able to slide axially and to be introduced into a cylinder in such a way that the piston is caused to act upon and expel from the cylinder the material to be processed.

The core of the present invention resides in a piston that features two sides that face away from each other, of which the first serves to act upon the material to be processed that is held in a bag inserted in the cylinder, and the second serves to act upon material to be processed that is held in a cartridge that has been loaded into the cylinder.

It will be appreciated that a number of advantages will be provided by a piston that can be arranged for the working both of bags that are inserted into the cylinder and of cartridges which, featuring a cylinder in which the material to be processed is stored, can be inserted into the device. The design of the first side of the piston, which serves to bear upon the bag, ensures that the bags will, while being worked, not sustain damage and will empty optimally. The second side of the piston permits the actuation, with uniformly distributed pressing force, of a part that is borne so as to slide inside an inserted cartridge, thus obviating damage thereto.

It is of particular advantage if the piston feature a threaded bore that runs the integral length of thereof and along the longitudinal axis thereof, so that the piston, having either its first or second side oriented toward the guide rod, can be screwed onto the threaded bolt of the guide rod.

It is particularly advantageous, for the purpose of more effectively emptying the bag, that the first side of the piston have a shape that at least approximates that of the inner wall of a covering piece, which, being secured to the forward end of the cylinder by means of a first assembly ring, is transited by the expelled material to be processed. The outside of the piston, once having reached its terminal position, is brought up against the inner wall of the covering piece, so that only the empty casing of the bag remains interposed therebetween.

It is consequently proposed in this respect that the folded casing of the bag not hinder the progress of the piston as it moves toward its terminal position. The outside diameter of the piston is smaller than the inside diameter of the cylinder, an arrangement that allows for the creation of a lateral storage space for the folded bag casing between the piston and the inner wall of the cylinder.

Provided on the second side of the piston is a plate whose elastic rim presses against the inner wall of the cylinder, thus allowing the now-emptied casing to be carried along, folded, and without being torn open. Such plate can either be attached as a separate part to the piston or form a unit together with the latter. Should the piston and plate constitute an integral unit, this should be preferably made from a synthetic material. Otherwise, it is preferable that the piston be manufactured from metal.

Should a separate plate be employed, it is preferable that a sealing ring be provided between the piston and the plate so as to prevent pieces of casing from becoming caught between piston and plate. Should the separate plate not possess sufficient rigidity, it is preferable that a support element be interposed between such separate plate and the guide rod in order to prevent deformation of the plate.

Provided so as to allow the separate plate to remain centred is an annular rib which, being arranged concentrically relative to the centre of such plate, is capable of fitting into a corresponding annular recess provided in the second side of the piston.

The cylinder, which serves to accommodate the bag, is preferably connected detachably to a second assembly ring held by the actuation apparatus. The cylinder can be opened if the first assembly ring and the covering piece are detached from the cylinder or if the cylinder is disengaged from the second assembly ring by being rotated, either operation being employed by many users as required. Rotation of the cylinder, however, exerts a torque moment both on the plate that rests against the inner wall of the cylinder and on the piston that also comes into contact with such cylinder, and so causes the piston to detach with little from the guide rod. The piston must then be reattached to the guide rod, which involves physically reaching into the dirty insides of the device. It is proposed that, in order to obviate this problem, the piston in a further advantageous embodiment of the invention feature at least on its first side and concentrically relative to the outlet opening of the threaded bore, a preferably cylindrical recess that serves at least to partially accommodate the head of a counter screw, which can be threaded into the threaded bore in the direction of the guide rod, which is introduced from the second side, until both meet, whereby the piston is fixed in position and cannot be work loose from the guide rod unless the counter screw is removed.

The present invention can be employed in devices whose actuation apparatus are either manually, electrically, pneumatically or hydraulically powered.

### BRIEF OVERVIEW OF THE DRAWINGS

Embodiment examples of the present invention will next be described in greater detail with the aid of drawings. Shown are:

FIG. 1 a longitudinal section through a cylinder 9, which can be connected at its forward end with the aid of a first assembly ring 8 to a covering piece 7 and inside which a guide rod 1 that is actuated by means of an actuation apparatus (see FIG. 9) is able to slide axially, guide rod 1 being fitted at its forward end with a terminal piece having a threaded bolt 12, onto which can be threaded a proposed piston 5 that features a threaded bore 51 that extends along the longitudinal axis xₖ thereof;

FIG. 2 piston 5 of FIG. 1, whose first side 5 A is oriented toward the front, accommodates a threaded bolt 12 which, having been screwed into threaded bore 51, is secured by means of counter screw 6;

FIG. 3 piston 5 of FIG. 1, whose second side 5 B is oriented toward the front, accommodates a threaded bolt 12 that has been screwed into threaded bore 51;

FIG. 4 piston 5 with counter screw 6 from FIG. 2 with a view of first side 5A;

FIG. 5 piston 5 of FIG. 2 with a view of second side 5B;

FIG. 6 the interconnected parts 1, . . . 9 of device 10 of FIG. 1;

FIG. 7 device 10 of FIG. 6, after guide rod 1 with first side 5A of piston 5 has been brought up against inner wall 74 of covering piece 7;

FIG. 8 device 10 of FIG. 6 during the working of an inserted bag 200 and the expulsion of the material to be dispensed 202 contained therein as well as a sausage-shaped bag 200;

FIG. 9 device 10 of FIG. 8 shortly prior to the complete emptying of inserted bag 200;

FIG. 10 a cartridge 300 bearing a part 301 that is capable of sliding therein, on which part second side 5B of piston 5, which is screwed onto guide rod 1, bears;

FIG. 11 piston 5, which is screwed onto guide rod 1 and secured by means of counter screw 6, against which a plate 58, which is profiled to fit such piston 5, sits; and

FIG. 12 piston 5 of FIG. 11 that has been screwed facing in the opposing direction onto guide rod 1.

In order to depict only the most essential parts of the invention, some elements have been omitted, for example, the housing of the invention.

### THE EMBODIMENTS OF THE PRESENT INVENTION

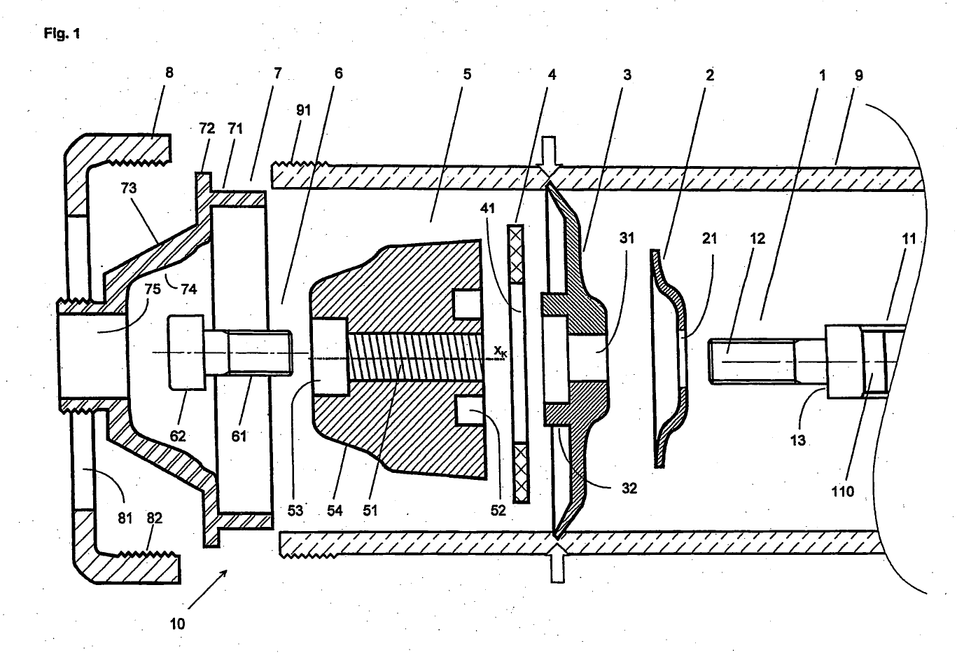

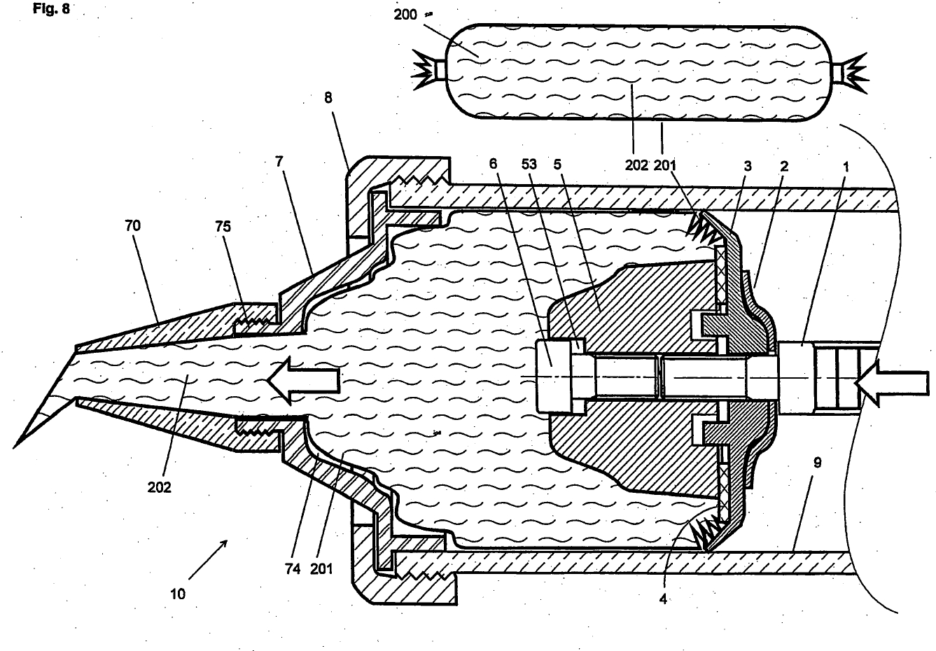

FIG. 1 shows an exploded view of not yet assembled parts 1, . . . , 9 of a preferred embodiment of device 10. Shown is a longitudinal section through a cylinder 9 which, being provided on both ends with an outer thread 91 (also see FIG. 7), can be connected frontally by means of a first assembly ring 8 to a covering piece 7. Capable of sliding axially inside cylinder 9 is a guide rod 1 which, being actuated by means of an actuation apparatus 800 (shown in FIG. 9), comprises a toothed rack 11 that is provided with a row of teeth 110 and a frontally-positioned terminal piece, which, in the manner of a screw, is provided with a threaded bolt 12 and a headpiece that forms a stop 13, such headpiece constituting part of toothed rack 11.

Also illustrated are a support element 2, a plate 3 and a sealing ring 4, each of which features a passage opening 21; 31 or 41 for the insertion of threaded bolt 12.

Also shown is a piston 5 that features a threaded bore 51, which, extending along the longitudinal axis x_{K} thereof, is accessible from sides 5A and 5B of piston 5 and is suitable for the insertion of threaded bolt 12 of guide rod 1 as well as of threaded shaft 61 of a counter screw 6.

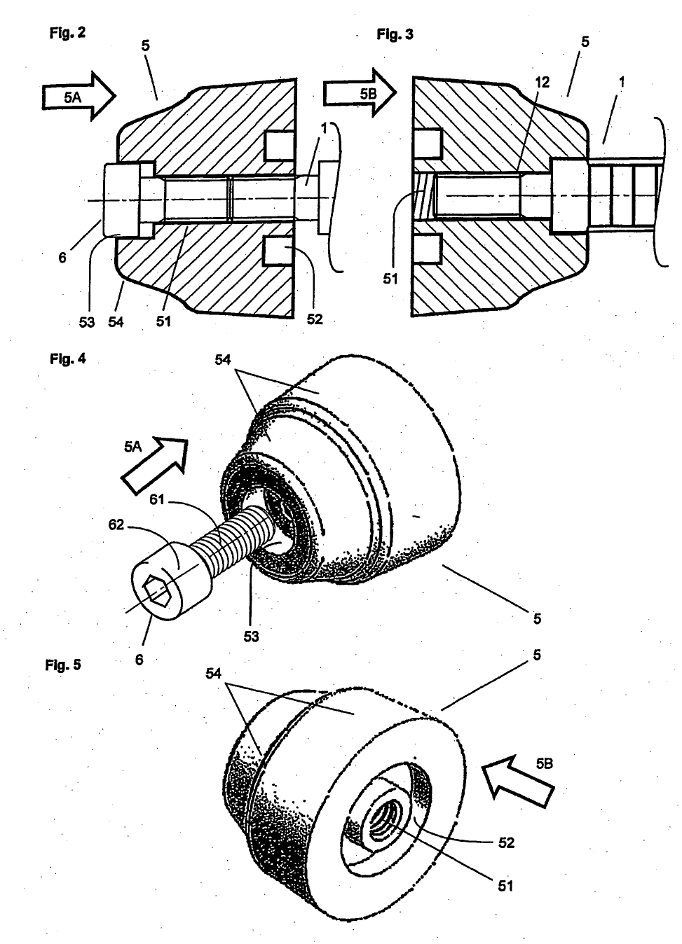

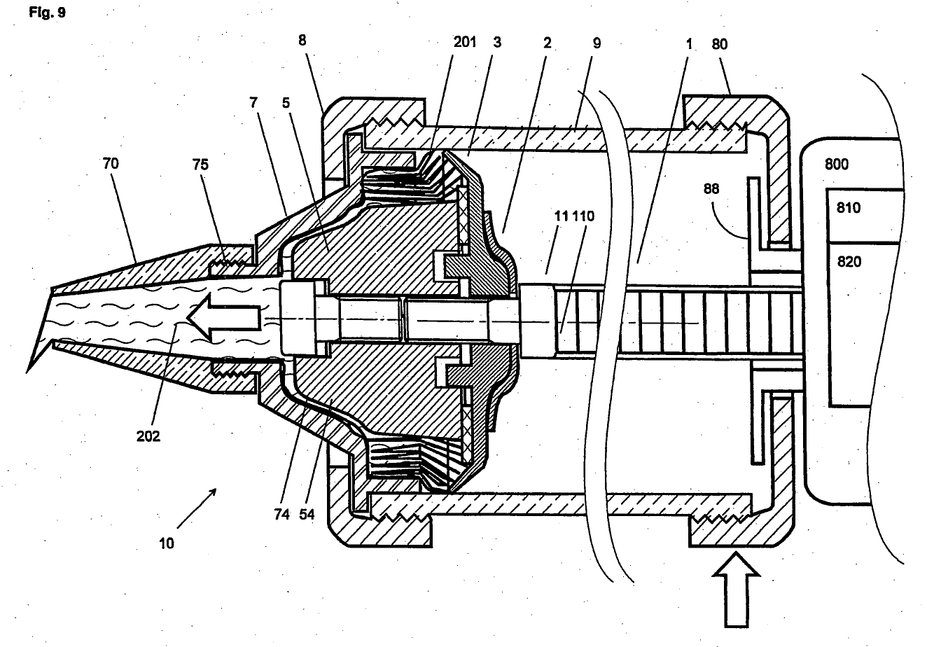

FIG. 2 illustrates piston 5 of FIG. 1, whereof side 5A, which serves to bear upon a bag 200 (see FIG. 8), faces toward the left. Threaded into threaded bore 51 from the direction of second side 5B of piston 5, which, facing right, serves to bear upon single-use cartridges, is threaded bolt 12 of guide rod 1. In order to secure threaded bolt 12 inside threaded bore 51, counter screw 6 was screwed from first side 5A into threaded bore 51 against threaded bolt 12 and tightened. Piston 6 can thus work loose from guide rod 1 only if counter screw has been removed, which prevents unintentional detachment of piston 5 following various kinds of manipulation of device 10 (see description accompanying FIG. 7).

FIG. 3 shows piston 5 of FIG. 1, whereof second side 5B faces left and wherein a threaded bolt 12 has been threaded into threaded bore 51 from the direction of first side 5A.

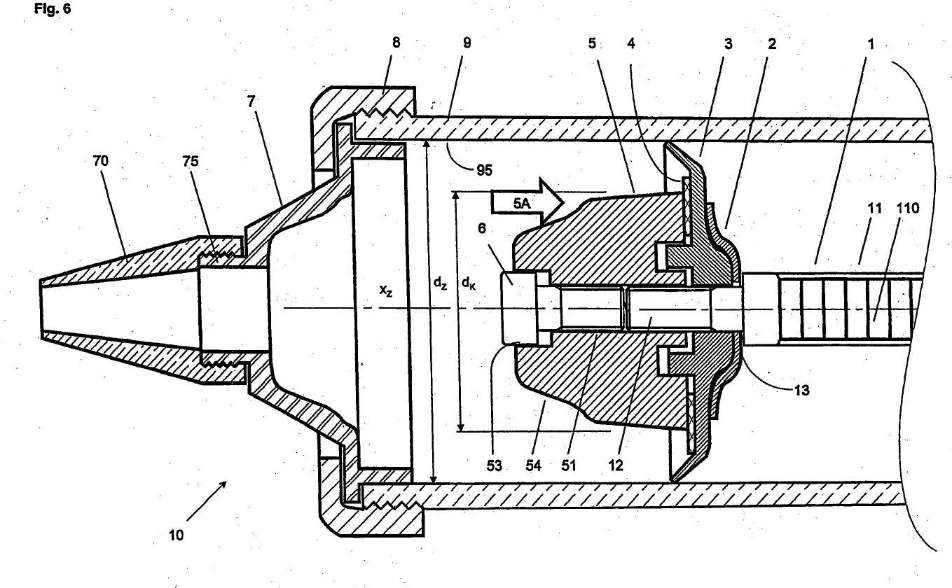

FIG. 4 is a spatial representation of piston 5 of FIG. 1 with a view of first side 5A.

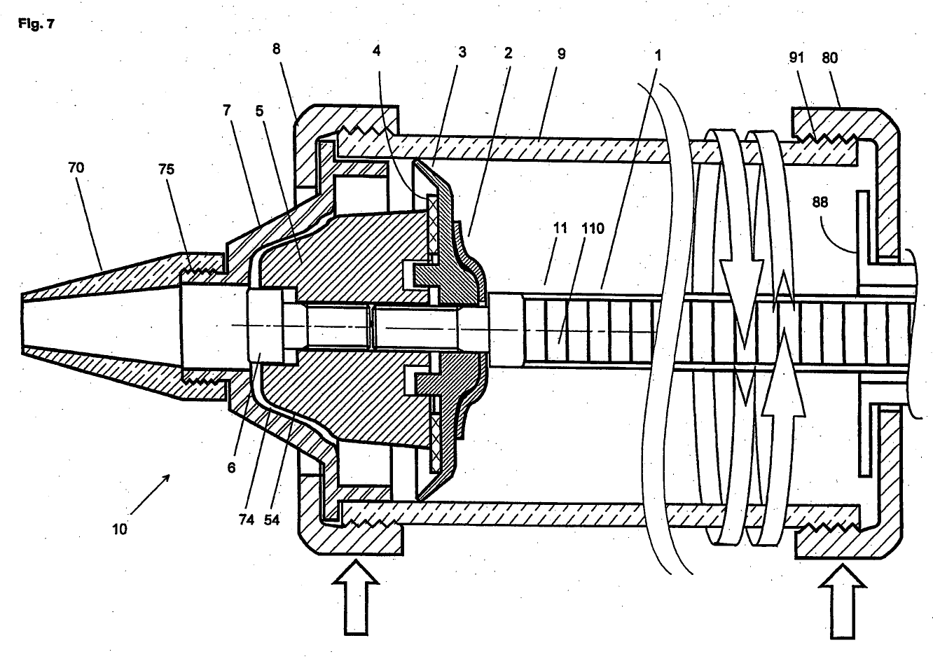

FIG. 5 is a spatial representation of piston 5 of FIG. 1 with a view of second side 5B.

FIG. 6 shows device 10 following assembly of piston 5, whose first side 5A is oriented forwardly in the direction of covering piece 7 which, being attached to cylinder 9, features an outlet cylinder 75 which, being provided with an outer thread, fits on top of outlet nozzle 70.

Threaded bolt 12 of guide rod 1 was inserted through the outlet openings 21; 31 or 41 in support element 2, in plate 3 and in sealing ring 4, all of which were bolted together with piston 5. In order to obviate any unintentional detachment of piston 5, counter screw 6 was introduced from first side 5A into threaded bore 51 and tightened.

Elastic plate 3 features an external rim which, being provided preferably with a slot, is pressed by inner wall 95 of cylinder 9 in the direction of cylinder axis x_{z} that runs coaxially relative to piston axis xₖ, so as to prevent casing 201 of bag 200 while being worked from catching between the rim of plate 3 and inner wall 95 of cylinder 9. Employment of sealing ring 4 prevents casing 201 of bag 200 while being worked from catching between plate 3 and piston 5. Support element 2, which sits against stop 13 of guide rod 1, holds plate 3 securely in position, so that plate 3 is unable to deform as bag 200 is being worked.

In order to secure plate 3, which comprises preferably synthetic material, concentrically relative to axis xₖ of piston 5, the latter features on second side 5B an annular recess 52 which, being disposed concentrically relative to the outlet opening of threaded bore 51, accommodates an annular rib 32 that is arranged in plate 3 concentrically to the centre thereof.

FIG. 6 also indicates that the external diameter dₖ of piston 5 is designed to be markedly smaller than the inside diameter d_{z} of cylinder 9. This arrangement provides for the creation, between piston 5 and inner wall 95 of cylinder 9, of a region in which to store folded casing 201 of emptied bag 200 (see FIG. 9). This arrangement permits the sequential folding and complete expulsion of material from bag 200 while preventing folded casing 201 from impeding the forward progress of piston 5. This arrangement is particularly advantageous, since piston 5 no longer has to press down upon numerous folded layers 201 of bag 200 as is the case in JP 11036571 and JP 7041021, but can, through only a single layer of casing 201, bear optimally upon material to be processed 202. This advantage will be clearly appreciated from FIGS. 7 and 9.

FIG. 7 shows device 10 of FIG. 6, after guide rod 1 and first side 5A of piston 5 have been brought up against inner wall 74 of covering piece 7. First side 5A of piston 5, or, in other words, the profile 54 of piston r in this region (see the spatial representation in FIGS. 4 and 5) is designed to correspond with the profile of inner wall 74 of covering piece 7, so that when piston 5 is brought up to meet covering piece 7, the volume enclosed between them will be unnoticeably small—in other words, occupied solely by casing 201 of bag 200. Bag 200 is thus completely emptied and folded. The action of piston 5 upon bag 200 remains optimal until bag 200 is completely emptied. Due to the fact that piston 5 always bears on material to be expelled 202 through only a single layer of casing 201, bag 200 can be more readily emptied with the exertion of less force. This arrangement permits the employment of more cost-effective actuation arrangements and the reduction of energy use, which is of special advantage where batteries for electrical drives are used.

Also shown in FIG. 7 is that cylinder 9 can, if rotated relative to first or second assembly ring 8, 80, be loosened and opened for the purpose of removing a spent bag 200 or the casing 201 thereof and inserting a fresh bag 200. If cylinder 6 is rotated relative to piston 5 or, rather, to plate 5 attached thereto, counter screw 6 will prevent piston 5 from rotating together with cylinder 9 and detaching from threaded bolt 12 of guide rod 1.

FIG. 8 shows device 10 of FIG. 6 during the working of bag 200 and the expulsion, through nozzle 70, of material to be processed 202 contained in bag 200. It can be seen that casing 201 is sequentially folded with the aid of plate 3, without the risk of casing 201 sliding between inner wall 95 of cylinder 9 and the rim of plate 3 or, rather, between piston 5 and the inner side of plate 3. As casing 201 is being laterally folded and completely emptied, piston 5, which is separated by a single layer of casing 201 from material to be processed 202, is impelled further forward until it meets covering piece 7 or, rather, its inner wall 74, whereby the last remaining portion of material to be processed 202 is forced out of bag 200.

FIG. 8 also shows a sausage-shaped bag 200 containing a material to be processed 202 that is enclosed inside a casing 201. Prior to the insertion in cylinder 9 of bag 200, the forward end thereof is cut open to allow material to be processed 202 to exit.

FIG. 9 shows device 10 of FIG. 8 shortly prior to the complete emptying of inserted bag 200. Piston 5 under further forward impulsion is caused to press against inner wall 74 of covering piece 7 so as to mate therewith. Any material to be processed 202 remaining in outlet opening 75 of the covering piece and in the channel of nozzle 70 is not wasted when bag 200 is replaced, but is merely expelled when a freshly-loaded bag 200 is worked.

Emptied bag 200 can be quickly removed in a few simple steps, since the invention ensures that bag casing 201 will be properly folded and not become jammed between parts of device 10. Since piston 5 is secured by means of counter screw 6, it is also proposed that such piston will not come loose and require subsequent reattachment. The smooth surfaces of the device parts ensure furthermore that bag casing 201 will not sustain damage while bag 200 is being worked and therefore will not cause soiling due to leakage of material to be processed 202.

FIG. 9 also shows actuation apparatus 800 which holds second assembly ring 80 and thus cylinder 9 by means of a connecting ring 88. Actuation apparatus 800 comprises preferably an electric motor 820 that is supplied with current from an accumulator 810. It is, however, as JP 11036571, JP 2003213926 or JP 7041021, instruct, also possible to actuate drive rod 1 by means of a manually-powered device. It is, of course, also possible to employ pneumatic or hydraulic drives.

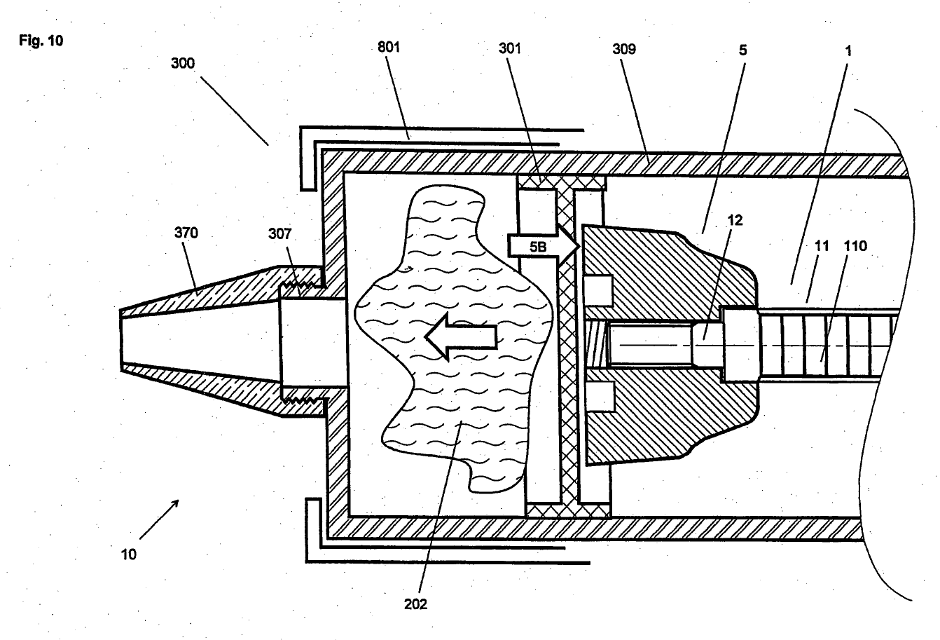

FIG. 10 shows a single-use cartridge 300 which, having been inserted into a holding device 801 of device 10, features a part that is borne and capable of sliding therein and against which second side 5B of piston 5, which is screwed onto guide rod 1, presses. Second side 5B of piston 5 for this purpose sits flat against part 301 so that the latter will be subjected to loading uniformly over its integral surface and thus sustain neither deformation nor damage.

Cartridge 300, which, after being worked, is either disposed of or refilled, features a cylinder 309 that is provided at its forward end with a covering piece 307 that has an outlet opening and an outer thread onto which a nozzle 370 is screwed.

Piston 5 can, therefore, be shifted with a minimum of effort from a first position serving to work bags 200, into a second position serving the working of cartridges, whereby each active side 5A or 5B of piston 5 is optimally adapted to the object to be worked 200, 300.

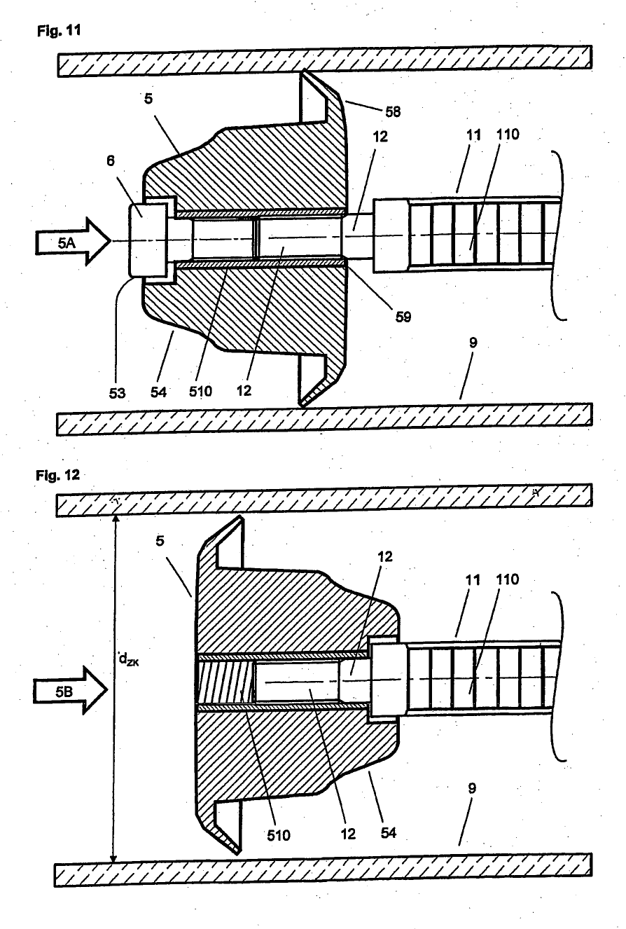

It will doubtless be appreciated that the present invention is not limited to the configuration examples illustrated and described. It is therefore proposed that a variety of different materials be suitable for use in the manufacture of the various parts of the device. The proposed device can, moreover, be manufactured in a variety of size formats, according to user requirements. Individual functional parts of the device can be modified while retaining their functionality, should a given function not be essential, the part in question can be omitted. For example, sealing ring 4 can be omitted if there is no danger of bag casing 201 becoming jammed. Furthermore, different parts can be consolidated and integrated into more streamlined modules. For example, FIGS. 11 and 12 show that piston 5 and plate 3 can be consolidated to form a unit, which permits sealing ring 4 and, if need dictates, support element 2 to be omitted.

FIG. 11 shows a piston 5, which, having been screwed onto guide rod 1 and secured by means of counter screw 6, has a shape that corresponds to that of a plate 58. First side 5A of piston 5 is oriented toward aperture 75 provided to permit the egress of material to be processed 202. In the present configuration, piston 5 is made of synthetic material for which purpose threaded bore 51 has been substituted with a tube 510 provided with an inner thread.

FIG. 12 shows piston 5 of FIG. 11 having been screwed, its orientation reversed, onto guide rod 11 the second side 5B whereof is oriented in the direction of aperture 75 provided for the egress of material to be processed 202. It can be seen from FIG. 12, however, that inside diameter d_{zk} of cylinder 309 of cartridge 300 should exceed cylinder 9 of device 10, so that piston 5 is prevented from jamming when being withdrawn from cartridge 300.

Piston 5, which is illustrated in FIGS. 11 and 12, is more cost-effective to produce and easier to assemble than the corresponding device parts 2, 3, 4 and 5 shown in FIG. 1. The functions are, however, identical.

As has been described above, device 10 permits the working of bags 200 that are inserted into cylinder 9 of device 10, or of cartridges 300 that are inserted into either a suitable holding device 801 or into cylinder 9 of device 10. If the employment of cartridges 300 is not contemplated, the proposed device 10 can with particular advantage be used uniquely for the working of bags 200. For example, device 10 can be employed in the configuration shown in FIG. 6 or FIG. 11. In this arrangement, threaded bore, 51 extends the integral length of piston 5, if it is intended that counter screw 6 be inserted at the front. If it is not intended for a counter screw 6 to be employed, and piston 5 is to be employed with its first side 5A always facing forward, it is not necessary to provide a threaded bore 51 through cylinder 51 in such a limited application of proposed device 10.

### LIST OF REFERENCE CAPTIONS

10 Device
1 Guide rod
11 Toothed rack
110 Row of teeth
12 Threaded bolt
13 Stop
2 Support element
21 Passage opening in support element 2
200 Sausage-shaped bag
201 Bag casing
202 Material to be processed, such as sealant or agglutinant
3 Plate
31 Passage opening in plate 3
32 Annular rib
300 Single-use cartridge
301 Part borne so as to be capable of sliding
307 Covering piece of cartridge 300
309 Cylinder of cartridge 300
4 Sealing ring
41 Passage opening in sealing ring 4
5 Piston
5A First side of piston 5
5B Second side of piston 5
51 Threaded bore
52 Annular recess
53 Cylindrical recess
54 Shape of the surface of first side 5A of piston 5
58 Plate whose shape corresponds to that of piston 5
59 Sleeve having internal thread 51 introduced into piston 5
6 Counter screw
7 Covering piece
70 Outlet nozzle
71 Inner flange
72 Outer flange
73 Conical element
74 Inner wall of covering piece 7
75 Outlet cylinder with outer thread
8 First assembly ring
80 Second assembly ring
81 Passage opening in first assembly ring 8
82 Inner thread in first assembly ring 8
88 Connecting ring
800 Actuation apparatus
801 Holding device for single-use cartridges 300
810 Accumulator
820 Electric motor
9 Cylinder
91 Outer thread at the ends of cylinder 9
95 Inner wall of cylinder

1. Device (10) for dispensing materials to be processed (200), especially viscous or pasty materials such as sealing materials and agglutinants, having an actuation apparatus (800) by means whereof a guide rod (1) that is capable of being connected to a piston (5) is borne so as to be capable of sliding and can be introduced into a cylinder (9; 309) in such a way that piston (5) can act upon material to be processed (202) that is present inside cylinder (9; 309) and expel said material to be processed from cylinder (9; 309), characterized in that
piston (5) comprises two sides (5A, 5B) that face away from each other, that piston (5), being oriented with either the first or the second side (5A, 5B) thereof in the direction of guide rod (1), can be screwed onto threaded bolt (12), that first side (5A) is suitably shaped in order to act upon a bag (200) that has been inserted into cylinder (9) and that second side (5B) is suitably shaped in order to act upon a cartridge (300) placed inside cylinder (9).

2. Device (10) in accordance with claim 1, characterized in that piston (5) features a threaded bore (51) that extends the integral length and along the longitudinal axis (xₖ) thereof, so that piston (5), with either the first or the second side (5A, 5B) being oriented in the direction of guide rod (1), can be screwed onto threaded bolt (12).

3. Device (10) in accordance with claim 1, characterized in that first side (5A) of piston (5) features a shape (54) that at least approximately corresponds to the shape (74) of inner wall (74) of a covering piece (7) that is secured by means of a first assembly ring (8) to the forward extremity of cylinder (9), and through which material to be processed (202) is expelled.

4. Device (10) in accordance with claim 3, characterized in that diameter dₖ of piston (5) is designed to be smaller relative to the inside diameter d_{z} of cylinder (9) in order to permit laterally between piston (5) and inner wall (95) of cylinder (9) the creation of a storage area for the folded casing (201) of emptied bag (200).

5. Device in accordance with claim 1, characterized in that provided on second side (5B) of piston (5) is a plate (3) whose elastic rim presses against inner wall (95) of cylinder (9), whereby plate (3) either forms part of piston (5) or constitutes a separate individual piece that lies thereagainst.

6. Device (10) in accordance with claim 5, characterized in that held between separate plate (3) and second side (5B) of piston (5) is a sealing ring (4) and/or that held between separate plate (3) and guide rod (1) is a support element (2).

7. Device (10) in accordance with claim 5, characterized in that separate plate (3) features an annular rib (32) which, being disposed concentrically relative to the centre thereof, can be introduced into a corresponding annular recess (52) that is provided on second side (5B) of piston (5).

8. Device (10) in accordance with claim 1, characterized in that piston (5) features on at least its first side (5A) and arranged concentrically relative to the outlet opening of threaded bore (51) a preferably cylindrical recess (53) that serves to at least partially accommodate the head (62) of a counter screw (6), that can be screwed into bore (51) in the direction of guide rod (1) that is introduced from second side 5B until these meet each other.

9. Device (10) in accordance with claim 1, characterized in that cylinder (9), which serves to accommodate bag (200), is detachably connected to a second assembly ring (80) that is held by actuation apparatus (800).

10. Device (10) in accordance with claim 1 characterized in that the shape of second side (5B) of piston (5) is adapted to an element (310) that is borne inside cartridge (300) so as to be able to slide.

11. Device (10) in accordance with claim 1 characterized in that a holding device (801) serving to accommodate cartridges (300) can be connected to actuation device (800).

12. Device (10) in accordance with claim 1, characterized in that the piston is produced from metal or from synthetic material.

13. Device (10) in accordance with claim 1, characterized in that actuation apparatus (800) can be powered manually, electrically, pneumatically or hydraulically.

14. Method (10) suitable for dispensing materials to be processed (200), especially viscous or pasty material such as sealing materials and agglutinants comprising an actuation apparatus (800) by means whereof a guide rod (1) is borne so as to be capable of axially sliding and of being introduced into a cylinder (9; 309) in such a way that piston (5) is capable of acting upon and expelling material to be processed (202) that is present in cylinder (9; 309), characterized in that piston (5) features two sides (5A, 5B) that face away from each other, that, during application of the materials to be processed that are present inside a bag (200), the piston is screwed onto guide rod (1) in such a way that first side (5A) of the piston acts upon the bag, and that during the application of material to be processed that is present inside a cartridge (300). the piston is screwed onto guide rod (1) in such a way that second side (5A) of the piston is caused to act upon the cartridge.
